(19) United States
(12) Patent Application Publication
(10) Pub. No.: US 2026/0321575 A1
(43) Pub. Date: Oct. 15, 2026

(54) METHOD FOR MANUFACTURING LITHIUM SECONDARY BATTERY HAVING HIGH-CAPACITY AND HIGH-STABILITY THROUGH MAGNETIC FIELD APPLICATION

(71) Applicant: THE INDUSTRY & ACADEMIC COOPERATION IN CHUNGNAM NATIONAL UNIVERSITY (IAC), Daejeon (KR)

(72) Inventors: Sung-Soo Kim, Daejeon (KR); Seonghyeon Lim, Daejeon (KR); Nurzhan Umirov, Daejeon (KR); Sanggu Ji, Daejeon (KR)

(21) Appl. No.: 18/998,764

(22) PCT Filed: Jul. 27, 2023
(86) PCT No.: PCT/KR2023/010897

§ 371 Date: Jan. 27, 2025

(30) Foreign Application Priority Data
Jul. 27, 2022 (KR) 10-2022-0093302

(51) Int. Cl. H01M 4/04; H01M 10/0525; H01M 50/609

(52) U.S. Cl. CPC H01M 4/0445; H01M 10/0525; H01M 50/609

(57) ABSTRACT

The present invention relates to a lithium secondary battery having high capacity and high stability through magnetic field application and, to a lithium secondary battery which maintains a stable battery capacity even under fast-charging conditions, and which can recycled. A method for manufacturing the lithium secondary battery, according to the present invention, can form a stable SEI film on the surface of an electrode inside a cell. Therefore, lifespan characteristics of a battery are improved, output characteristics thereof are enhanced, battery capacity can be stably maintained even under fast-charging conditions, and battery resistance decreases, thereby enabling battery recycling.

### TECHNICAL FIELD

The present invention relates to a lithium secondary battery having high capacity and high stability through magnetic field application, and a lithium secondary battery which maintains a stable battery capacity even under fast charging conditions and may be recycled.

### BACKGROUND ART

As the IT technology and the electric vehicle battery markets grow, technical research in the industry of a lithium secondary battery which is a core component used as an energy Source is continuing. Since a lithium secondary battery has merits of high energy density, excellent life characteristics, and low self-discharge, as an energy source, it is being applied to various fields and becoming more important as an energy storage device.

During a manufacturing process of the lithium secondary battery, a lithium ion is inserted into a negative electrode from a lithium metal oxide of a positive electrode in a formation process. In this process, a solvent component of an electrolyte for a lithium secondary battery reaches a reduction potential, and organic materials such as Li₂CO₃, LiO, and LiOH which are reduction by-products are produced on the surface of the negative electrode to form a coating film. The coating film formed on the surface of the negative electrode as such is called a solid electrolyte interface (SEI, hereinafter, referred to as an SEI film). The SEI film is a nonconductor having no electronic conductivity, and when it is formed once during first charging, it prevents a reaction of a lithium ion and a negative electrode or other materials on a negative electrode surface during repeated charging/discharging and serves as an ion tunnel which allows only the lithium ion to pass through between an electrolyte solution and the negative electrode.

In addition, the SEI film is a core element which determines battery safety, power capacity, leakage current, Shelf life, and a lifetime. Since SEI film which is stably produced in an initial formation process does not cause a side reaction with a carbon negative electrode or other materials, it reversibly maintains an amount inserted/desorbed lithium ions and prevents structural collapse of a structure of a carbon negative electrode by inserting the lithium ions and anions dissolved in an organic Solvent together. As a result, the SEI film which serves as an entrance of stably formed ions secures reversibility of a charging/discharging reaction of a secondary battery after the formation process and suppresses a further increase in resistance.

That is, a lithium secondary battery repeats contraction and expansion as charging/discharging is performed, which causes peeling off of an electrode active material from a current collector to deteriorate charge/discharge efficiency and cycle characteristics, and in order to prevent the problem, stable formation of the SEI film is needed.

Conventionally, there was an attempt to improve the composition of an electrolyte solution or a negative electrode material to stably form the SEI film or improve a manufacturing process of a lithium secondary battery to form stable SEI film, but this was not effective. Thus, development of a recyclable high-efficiency lithium secondary battery which maintains a stable battery capacity even under fast charge conditions by forming a stable SEI film on the surface of the negative electrode of the lithium secondary battery is needed.

### DISCLOSURE

### Technical Tasks

An object of the present invention is to provide a method for manufacturing a lithium secondary battery which has improved battery output by designing a formation process.

Another object of the present invention is to provide a method for manufacturing a lithium secondary battery which secures stability even under harsh conditions such as fast charging/discharging.

Still another object of the present invention is to provide a method for manufacturing a lithium secondary battery which may be recycled even when a life retention rate is low due to increased battery resistance.

### Technical Solution

In one general aspect, a method for manufacturing a lithium secondary battery includes: (a) an electrode plate process step of manufacturing a positive electrode plate and a negative electrode plate; (b) an assembly process step of performing assembly by including a separator in the positive electrode plate and the negative electrode plate and injecting an electrolyte solution to manufacture a cell; and (c) an activation process step of performing a formation process on the manufactured cell, wherein a magnetic field is applied in the formation process of (c).

In the method for manufacturing a lithium secondary battery according to an example embodiment of the present invention, the applied magnetic field may have an intensity of 0.1 to 2.0 T and a frequency of 1 to 30 Hz, and an application time of the applied magnetic field may be 1 to 60 minutes.

In the method for manufacturing a lithium secondary battery according to an example embodiment of the present invention, a current applied in (c) may be 0.01 to 1.0 C, and a time of the current applied in (c) may be 1 to 10 hours.

In another general aspect, a lithium secondary battery manufactured by the manufacturing method is provided.

In the lithium secondary battery according to an example embodiment of the present invention, the lithium secondary battery may have an initial discharge capacity of 20 mAh/g or more, an initial coulombic efficiency of 85% or more, and a discharge capacity ratio of 18% or more.

### Advantageous Effects

The method for manufacturing y a lithium secondary battery according to the present invention may form a stable SEI film on the surface of an electrode inside a cell. Thus, life characteristics of a battery are improved, output characteristics thereof are improved, a battery capacity may be stably maintained even under fast charge conditions, and battery resistance is decreased, thereby allowing battery recycling.

### DESCRIPTION OF DRAWINGS

FIG. 1 is a graph showing discharge capacities depending on charge/discharge cycles of lithium secondary batteries manufactured by the manufacturing methods according to Examples 1 to 3.

FIG. 2. is a graph showing discharge capacities depending on charge/discharge cycles of lithium secondary batteries manufactured by the manufacturing methods according to Examples 4 to 6.

FIG. 3 is a graph showing discharge capacities depending on charge/discharge cycles of lithium secondary batteries manufactured by the manufacturing methods according to Examples 7 to 9,

FIG. 4 is a graph showing an initial discharge capacity depending on conditions of a magnetic field applied to a lithium secondary battery manufactured according to the present invention.

FIG. 5 is a graph showing an initial coulombic on conditions of a magnetic field efficiency depending applied to a lithium secondary battery manufactured according to the present invention.

FIG. 6 is a graph showing a discharge capacity ratio depending on conditions of a magnetic field applied to a lithium secondary battery manufactured according to the present invention.

FIG. 7 is a graph showing a retention ratio depending on conditions of a magnetic field applied to a lithium secondary battery manufactured according to the present invention.

FIG. 8 is a graph showing a discharge capacity when a magnetic field is applied during lithium secondary battery recycling.

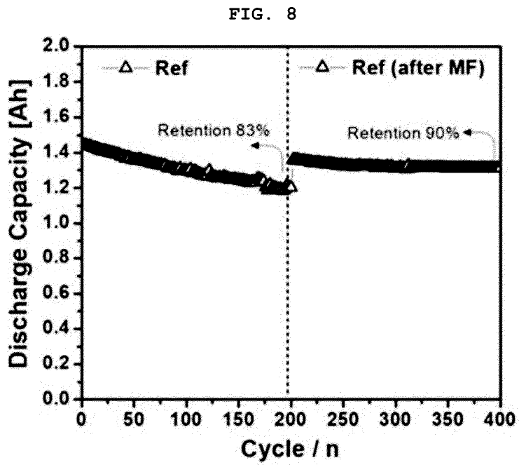

### EMBODIMENTS

Hereinafter, a method for manufacturing a lithium secondary battery of the present invention will be described in detail with reference to the accompanying drawing.

The drawings to be provided below are provided by way of example so that the idea of the present invention can be sufficiently transferred to a person skilled in the art to which the present invention pertains. Therefore, the present invention is not limited to the drawings provided below but may be embodied in many different forms, and the drawings suggested below may be exaggerated in order to clear the spirit of the present invention.

Herein, technical terms and scientific terms used in the specification have the general meaning understood by those skilled in the art to which the present invention pertains unless otherwise defined, and a description for the known function and configuration unnecessarily obscuring the gist of the present invention will be omitted in the following description and the accompanying drawings.

In addition, the singular form used in the specification and claims appended thereto may be intended to also include a plural form, unless otherwise indicated in the context.

In the present specification and the appended claims, the terms such as “first” and “second” are not used in a limited meaning but used for the purpose of distinguishing one constituent element from other constituent elements.

In the present specification and the appended claims, the terms such as “comprise” or “have” means that there is a characteristic or a constituent element described in the specification, and unless otherwise particularly defined, a possibility of adding one or more other characteristics or constituent elements is not excluded in advance.

In the present specification and the appended claims, when a portion such as a film (layer), a region, and a constituent element are present on another portion, not only a case in which the portion is in contact with and directly on another portion but also a case in which other films (layers), other regions, other constitutional elements are interposed between the portions is included.

The method for manufacturing a lithium secondary battery of the present invention includes: (a) an electrode plate process step of manufacturing a positive electrode plate and a negative electrode plate; (b) an assembly process step of performing assemble by including a separator in the positive electrode plate and the negative electrode plate and injecting an electrolyte solution to manufacture a cell; and (c) an activation process step of performing a formation process on the manufactured cell, wherein a magnetic field is applied in the formation process of (c). Herein, in the activation process step, an aging process may be further performed before or after the formation process.

An SEI film formed on a surface of a negative electrode in the formation process is a core element which determines battery safety, power capacity, shelf life, and the like, and according to the manufacturing method of the present invention, a dissociation reaction of ions generated in an interface and movement of electrons solvated from a negative electrode are activated by applying a magnetic field in the formation process to form a uniform and stable SEI film in the electrode interface.

In a specific example, the electrode plate process step (a) is a process of manufacturing a positive electrode plate and a negative electrode plate. In the electrode plate process step, the positive electrode plate and the negative electrode plate are manufactured by mixing an active material, a conductive material, and a binder and then coating, pressing laminating, and slitting the mixture.

The positive electrode plate may be formed on a positive electrode current collector. Herein, a porous body such as a reticulated or mesh shaped may be used as the positive electrode current collector, and a porous metal plate such as stainless steel, nickel, or aluminum may be used, but the present invention is not necessarily limited thereto, and any material is used as long as it may be used as a current collector in the art. In addition, the positive electrode current collector may be coated with an oxidation-resistant metal or an alloy coating film in order to prevent oxidation.

An active material used in the manufacture of the positive electrode plate may be a compound capable of reversible intercalation and deintercalation of lithium. Specifically, a lithium-containing transition metal oxide may be used, and more specifically, any one or a mixture of two or more selected from the group consisting of LiCoO₂, LiNiO₂, LiMnO₂, LiMn₂O₄, Li(NiₐCo_{b}Mn_{c})O₂ (0<a<1, 0<b<1, 0<c<1, a+b+c=1), LiNi_{1-y}CO_{y}O₂, LiCo_{1-y}Mn_{y}O₂, LiNi_{1-y}Mn_{y}O₂ (0≤y<1), Li(NiₐCO_{b}Mn_{c})O₄ (0<a<2, 0<b<2, 0<c<2, a+b+c=2), LiMn_{2-z}Ni_{z}O₄, LiMn₂₋₂ CO₂O₄ (0<z<2), LiCOPO₄, and LifePO₄, preferably Li(NiₐCo_{b}Mn_{c})O₂ (0<a<1, 0<b<1, 0<c<1, a+b+c=1), and more preferably, Li(Ni_{0.6}Co_{0.2}Mn_{0.2}) O₂ may be used. In addition, a sulfide, a selenide, a halide, and the like may be used, in addition to the oxides. In addition, a positive electrode active material in a Li-free form without lithium may be initially used, and more specifically, TiS₂, FeS₂, V₂O₅, or the like may be used.

A conductive material used in the manufacture of the positive electrode plate may be any material having porosity and conductivity without limitation, and more specifically, a porous carbonaceous material. The carbonaceous material may be carbon black, graphite, graphene, active carbon, carbon fiber, and the like. In addition, the conductive material may be a metal conductive material such as metal fiber and metal mesh; metallic powder of copper, silver, nickel, aluminum, and the like; or an organic conductive material such as a polyphenylene derivative. The conductive materials may be used alone or in combination.

The positive electrode plate may optionally further include a binder. The binder may be a thermoplastic resin or a thermoset resin, More specifically, as the binder, polyethylene, polypropylene, polytetrafluoroethylene (PTFE), polyvinylidene fluoride (PVDF), styrene-butadiene rubber, a tetrafluoroethylene-perfluoroalkylvinylether copolymer, a vinylidene fluoride-hexafluoropropylene copolymer, a vinylidene fluoride-chlorotrifluoroethylene copolymer, an ethylene-tetrafluoroethylene copolymer, polychlorotrifluoroethylene, a vinylidene fluoride-pentafluoropropylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethylvinylether-tetrafluoroethylene copolymer, an ethylene-acrylic acid copolymer, and the like may be used alone or in combination, but the present invention is not necessarily limited thereto, and any material used as a binder in the art may be used.

Therefore, the positive electrode plate may be manufactured by mixing a positive electrode active material, a conductive material, and, optionally, a binder to prepare a composition for forming a positive electrode active material layer, and then applying it on at least one surface of the positive electrode current collector, drying, and rolling. As another method, the positive electrode plate may be manufactured by casting the composition for forming a positive electrode active material layer on a separate support, peeling off from the support to obtain a film, and laminating the film on the positive electrode current collector.

The manufactured positive electrode plate may have a thickness of 10 to 100 μm, preferably 15 to 50 μm, and more preferably 20 to 30 μm. In addition, the manufactured positive electrode may have an area of 1 to 40 cm², preferably 3 to 30 cm², and more preferably 5 to 20 cm². Accordingly, the manufactured positive electrode may have a capacity per area of 1 to 10 mAh/cm², preferably 1.5 to 7.5 mAh/cm², and more preferably 2 to 5 mAh/cm².

In a specific example, the negative electrode plate may include a current collector and a negative electrode active material layer formed by applying a negative electrode slurry including a negative electrode active material on at least one surface of the current collector.

The negative electrode active material layer may include a negative electrode active material, and, optionally, may further include a binder and a conductive material. An example of the negative electrode active material may be a carbonaceous negative electrode active material, a silicon-based negative electrode active material, or a mixture thereof, but is not limited thereto. The carbonaceous negative electrode active material may be one or more selected from artificial graphite, natural graphite, and hard carbon. The silicon-based negative electrode active material may be Si, SiOₓ (0<x<2), a Si—Q alloy (Q is an element selected from the group consisting of alkali metals, alkaline earth metals, Group 13 elements, Group 14 elements, Group 15 elements, Group 16 elements, transition metals, rare earth elements, and a combination thereof, but not Si), a Si-carbon composite, or a mixture of at least one of them with SiO₂.

The current collector, the binder, and the conductive material which are used in the manufacture of the negative electrode plate are the same as those used in the manufacture of the positive electrode plate described above.

The manufactured negative electrode may have a thickness of 10 to 100 μm, preferably 20 to 70 μm, and more preferably 30 to 40 μm. In addition, the manufactured negative electrode may have an area of 1 to 40 cm², preferably 3 to 30 cm², and more preferably 5 to 20 cm². Accordingly, the manufactured negative electrode may have a capacity per area of 1 to 10 mAh/cm², preferably 1.5 to 7.5 mAh/cm², and more preferably 2 to 5 mAh/cm².

In a specific example, the assembly process step (b) is a process of processing and assembling the positive electrode plate, the negative electrode plate, and a separator to manufacture a cell having a battery form, and may be a step of manufacturing by inserting a cell into a pouch and then injecting an electrolyte solution.

The pouch may be formed by laminating an insulation layer, an adhesive layer, and a metal thin film, and as the pouch, those which are commonly used in the art may be adopted, More specifically, the metal thin film may include aluminum and the like, which may secure mechanical rigidity of the pouch and also block moisture and oxygen from the outside, but the present invention is not limited thereto.

In addition, an electrolyte solution may be injected into the pouch and contained therein, and a cell may be immersed in the electrolyte solution.

The electrolyte solution may include an organic solvent and a lithium salt. The organic solvent serves as a medium in which ions involved in an electrochemical reaction of a battery may move, and for example, may be carbonate-based, ester-based, ether-based, ketone-based, alcohol-based, or aprotic solvents and may be used alone or in combination of two or more, and a mixing ratio when used in combination of two or more may be appropriately adjusted depending on battery performance to be desired. More specifically, the organic solvent may be an organic solvent selected from the group consisting of ethylene carbonate (EC), ethylmethyl carbonate (EMC), dimethyl carbonate (DMC), diethyl carbonate (DEC), propylene carbonate, methylpropyl carbonate, dipropyl carbonate, acetonitrile, dimethoxyethane, diethoxyethane, sulfolane, and tetrahydrofuran.

In addition, the lithium salt is a material which is dissolved in the organic solvent and acts as a source of lithium ions in the battery to allow operation of the lithium secondary battery and promotes movement of lithium ions between a positive electrode and a negative electrode. More specifically, the lithium salt may be represented by Li⁺x⁻, and an anion (X⁻) of the lithium salt may be selected from the group consisting of F⁻, Cl⁻, Br⁻, I⁻, NO₃⁻, N(CN)₂⁻, BF₄⁻ClO₄⁻, PE₆⁻, (CF₃)₂PE₄⁻, (CF₃)₃PE₃⁻, (CF₃)₄PF₂⁻, (CF₃)₅PF⁻, (CF₃)₆P⁻, CF₃SO₃⁻/CF₃CF₂SO₃, (CF₃SO₂)₂N⁻, (FSO₂)₂N⁻, CF₃CF₂⁻, (CF₃)₂CO⁻, (CF₃SO₂)₂CH⁻, (SF₅)₃C⁻, (CF₃SO₂)₃C⁻, CF₃(CF₂), SO₃″, CF₃CO₂⁻, CH₃CO₂⁻, SCN⁻, and (CF₃CF₂SO₂)₂N⁻, and preferably, may be LiPE₆.

Herein, a concentration of the lithium salt in the electrolyte solution may be 0.1 to 10 M, preferably 0.3 to 5 M, and more preferably 0.5 to 2 M.

The separator may be polyethylene, polypropylene, polyvinylidene fluoride, or a multilayer of two or more thereof, and a mixed multilayer such as polyethylene/polypropylene two-layer separator, polyethylene/polypropylene/polyethylene three-layer separator, polypropylene/polyethylene/polypropylene three-layer separator may be used.

In a specific example, the activation process step (c) may be a step of imparting electrical properties by charging and discharging the assembled cell, and the formation process is performed on the cell manufactured by (b) and then an aging process may be performed.

In the formation process, in the lithium secondary battery, a lithium ion is inserted into a negative electrode from a lithium metal oxide of a positive electrode, and in this process, a solvent component of the electrolyte solution reaches its reduction potential, which causes production of organic matter such as Li₂CO₃, LiO, and LiOH which are reduction by-products on the surface of the negative electrode to form a coating film, which is called an SEI film. That is, in order to uniformly and stably form the SEI film, a dissociation reaction of ions generated in the interface should be increased, and also electron mobility which is solvated from the negative electrode should be increased, and for this, a magnetic field should be applied to the formation process.

Herein, the applied magnetic field may have an intensity of 0.1 to 2 T, preferably 0.2 to 1.5 T, and more preferably 0.3 to 1.0 T. In addition, the applied magnetic field may have a frequency of 1 to 30 Hz, preferably 2 to 25 Hz, and more preferably 3 to 1 15 Hz. In addition, an application time of the magnetic field may be 1 to 60 minutes, preferably 5 to 40 minutes, and more preferably 10 to 20 minutes. When the magnetic field satisfying the intensity, the frequency, and the time within the ranges is applied, the dissociation reaction of ions generated in the interface is increased, and also the mobility of ions solvated from the negative electrode is increased to form a uniform and stable SEI film, and thus, excellent electrical properties are shown in the lithium secondary battery including the SEI film.

In addition, the current applied in the formation process may have an intensity of 0.01 to 1.0 C, preferably 0.03 to 0.5 C, and more preferably 0.05 to 0.2 C. In addition, in the formation process, the current may be applied for 1 to 10 hours, preferably 1 to 5 hours, and more preferably 1 to 3 hours.

In the formation process, a time point at which the magnetic field is applied may be at the same time as the first charging of the positive electrode and the negative electrode immersed in the electrolyte solution. In addition, a time point at which the magnetic field application ends is when gassing is completed during the formation process.

After the formation process, an aging process may be further performed. The aging process is a process of allowing a battery to stand for a certain period of time for stabilizing an SEI coating film, and an electrolyte solution inside the battery is evenly dispersed through a process of storing the battery at temperature of 10 to 50° C. for 1 to 5 hours, so that ion movement is optimized.

Hereinafter, the present invention will be described in detail by the examples. However, the examples are for describing the present invention in more detail, and the scope of the present invention is not limited to the following examples.

### <Example 1> Manufacture of Lithium Secondary Battery

### 1-1; Electrode Plate Process Step

A slurry in which LiNi_{0.6}Co_{0.2}Mn_{0.2}O₂ as a positive electrode active material, polyvinylidene fluoride (PVdF) as a binder, and black-based carbon as a conductive material were mixed at a weight ratio of 95:3:2 was coated on an aluminum foil, dried, and rolled to manufacture a positive electrode plate. The thickness of the manufactured positive electrode plate was 25.5 μm, and the area of the positive electrode plate was 10.36 cm².

A negative electrode plate was manufactured using graphite as a negative electrode active material. The thickness of the manufactured negative electrode plate was 33 μm, and the area of the negative electrode plate was 12 cm².

### 1-2: Assembly Process Step

1.0 M LiPF₆ was dissolved in a solvent having a ratio of ethylene carbonate (EC):ethylmethyl carbonate (EMC):dimethyl carbonate (DMC)=1:1:1 as a volume ratio to prepare an electrolyte solution.

A polypropylene (PP) separator was placed between the positive electrode plate and the negative electrode plate manufactured in the electrode plate process step and wound, and the electrolyte solution was injected to manufacture a cell.

### 1-3: Activation Process Step

A current of 0.1 C was applied for 2 hours to perform a formation process. At this time, the magnetic field was further applied, and the magnetic field had an intensity of 0.5 T and a frequency of 5 Hz and the application time of the magnetic field was 5 minutes.

After performing the formation process, aging was performed at a temperature of 25° C. for 2 hours.

### Example 2

A lithium secondary battery was manufactured in the same manner as in Example 1, except that the application time of the magnetic field was 15 minutes instead of 5 minutes.

### Example 3

A lithium secondary battery was manufactured in the same manner as in Example 1, except that the application time of the magnetic field was 30 minutes instead of 5 minutes.

### Example 4

A lithium secondary battery was manufactured in the same manner as in Example 1, except that the frequency of the magnetic field was 10 Hz instead of 5 Hz.

### Example 5

A lithium secondary battery was manufactured in the same manner as in Example 2, except that the frequency of the magnetic field was 10 Hz instead of 5 Hz.

### Example 6

A lithium secondary battery was manufactured in the same manner as in Example 3, except that the frequency of the magnetic field was 10 Hz instead of 5 Hz.

### Example 7

A lithium secondary battery was manufactured in the same manner as in Example 1, except that the frequency of the magnetic field was 20 Hz instead of 5 Hz.

### Example 8

A lithium secondary battery was manufactured in the same manner as in Example 2, except that the frequency of the magnetic field was 20 Hz instead of 5 Hz.

### Example 9

A lithium secondary battery was manufactured in the same manner as in Example 3, except that the frequency of the magnetic field was 20 Hz instead of 5 Hz.

### COMPARATIVE EXAMPLE

A lithium secondary battery was manufactured in the same manner as in Example 1, except that the magnetic field was not further applied. The results of the comparative example are shown as “ref” in the drawings shown below.

### <Experimental Example 1> Evaluation of Efficiency of Lithium Secondary Battery for Each Cycle

The electrochemical properties of the cells manufactured by the manufacturing method of Examples 1 to 9 and the comparative example were evaluated.

Changes in a discharge capacity and a discharge capacity retention rate depending on the performance of the charge/discharge cycle were measured.

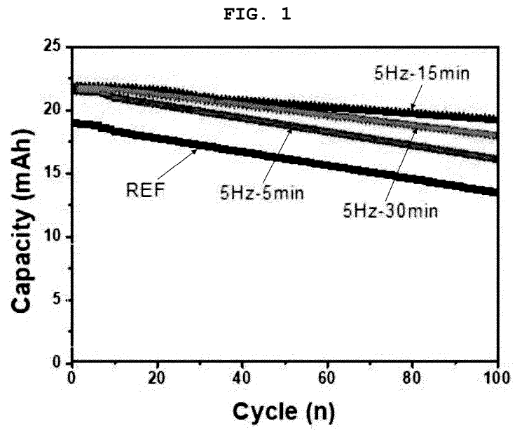

First, cells manufactured by applying magnetic fields having a frequency of 5 Hz according to Examples 1 to 3 to a formation process were evaluated. Referring to FIG. 1, upon review of the discharge capacity after 100 cycles, it was confirmed that when the magnetic field was applied, the discharge capacity retention rate was high as compared with the comparative example to which the magnetic field was not applied, and among them, it was confirmed that the discharge capacity retention rate was the highest in the cell to which the magnetic field was applied for 15 minutes.

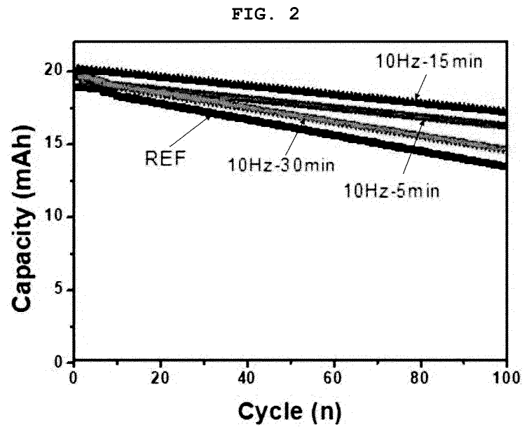

Next, cells manufactured by applying magnetic fields having a frequency of 10 Hz according to Examples 4 to 6 to a formation process were evaluated. Referring to FIG. 2, upon review of the discharge capacity after 100 cycles, it was confirmed that when the magnetic field was applied, the discharge capacity retention rate was high as compared with the comparative example to which the magnetic field was not applied, and among them, it was confirmed that the discharge capacity retention rate was the highest in the cell to which the magnetic field was applied for 15 minutes.

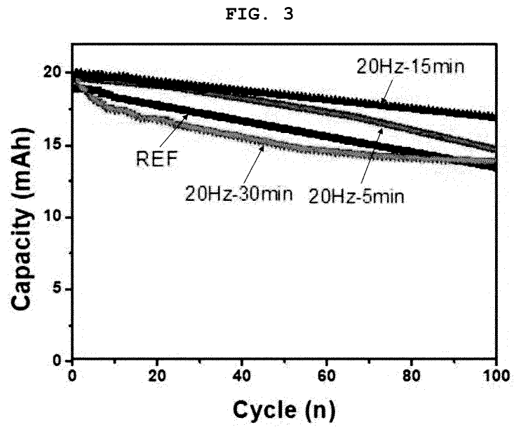

Next, cells manufactured by applying magnetic fields having a frequency of 20 Hz according to Examples 7 to 9 to a formation process were evaluated. Referring to FIG. 3, upon review of the discharge capacity after 100 cycles, it was confirmed that when the magnetic field was applied, the discharge capacity retention rate was high as compared with the comparative example to which the magnetic field was not applied, and among them, it was confirmed that the discharge capacity retention rate was the highest in the cell to which the magnetic field was applied for 15 minutes.

That is, it was confirmed that the lithium secondary batteries manufactured according to the manufacturing methods of Examples 1 to 9 had a low decrease in the discharge capacity as compared with the lithium secondary battery manufactured according to the comparative example as the number of charge/discharge cycles increased, and thus, it was confirmed that the lithium secondary batteries to which a magnetic field was applied in a formation process had excellent capacity retention performance.

### <Experimental Example 2>Evaluation of Electrochemical Properties of Lithium Secondary Battery

### 1. Evaluation of Initial (1^{st}) Discharge Capacity

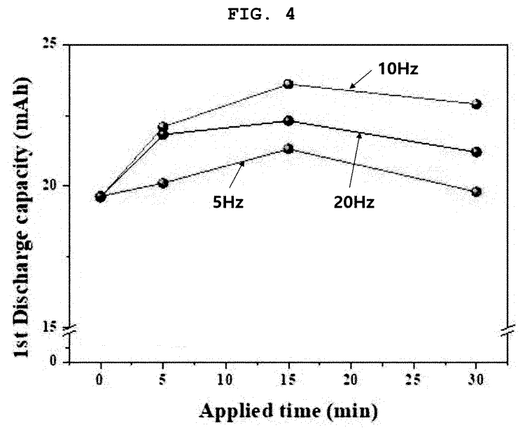

Referring to Table 1 and FIG. 4, when the magnetic field frequency was 10 Hz as in Examples 4 to 6, an initial discharge capacity was high in the case of applying the magnetic field for the same period of time as compared with not only the comparative example to which the magnetic field was not applied but also Examples 1 to 3 having the magnetic field frequency of 5 Hz and Examples 7 to 9 having the magnetic field frequency of 20 Hz. In addition, even in the case of applying the magnetic field having the same frequency, when the magnetic application time was 15 minutes (Examples 2, 5, and 8), it was confirmed that the initial discharge capacity was high. Therefore, when the magnetic field having the frequency of 10 Hz was applied for 15 minutes, as in Example 5, the initial discharge capacity was the highest at 23.6 mAh.

TABLE 1

| | Initial discharge |
|---|---|
| | capacity (mAh/g) |
| Example 1 | 20.1 |
| Example 2 | 21.3 |
| Example 3 | 19.8 |
| Example 4 | 22.1 |
| Example 5 | 23.6 |
| Example 6 | 22.9 |
| Example 7 | 21.8 |
| Example 8 | 22.3 |
| Example 9 | 21.2 |
| Comparative Example | 19.6 |

### 2, Evaluation of Initial Coulombic Efficiency (ICE)

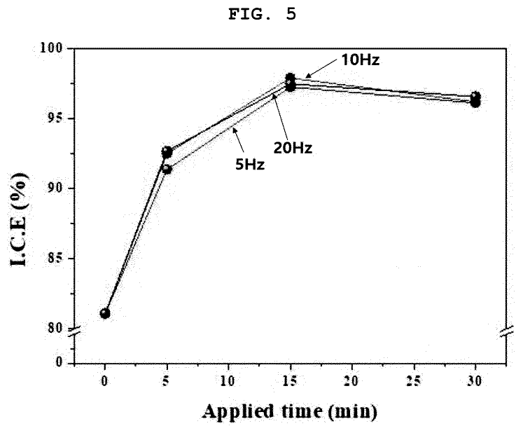

Referring to Table 2 and FIG. 5, when the magnetic field frequency was 10 Hz as in Examples 4 to 6, an initial coulombic efficiency was high in the case of applying the magnetic field for the same period of time as compared with not only the comparative example to which the magnetic field was not applied but also Examples 1 to 3 having the magnetic field frequency of 5 Hz and Examples 7 to 9 having the magnetic field frequency of 20 Hz. In addition, even in the case of applying the magnetic field having the same frequency, when the magnetic field application time was 15 minutes (Examples 2, 5, and 8), it was confirmed that the initial coulombic efficiency was high. Therefore, when the magnetic field having the frequency of 10 Hz was applied a for 15 minutes as in Example 5, it was confirmed that the initial coulombic efficiency was the highest at 97.9%.

TABLE 2

| | Initial coulombic |
|---|---|
| | efficiency (%) |
| Example 1 | 91.4 |
| Example 2 | 97.3 |
| Example 3 | 96.1 |
| Example 4 | 92.5 |
| Example 5 | 97.9 |
| Example 6 | 91.2 |
| Example 7 | 92.7 |
| Example 8 | 97.5 |
| Example 9 | 96.6 |
| Comparative Example | 81.1 |

### 3. Evaluation of Discharge Capacity Ratio (Rate Capability)

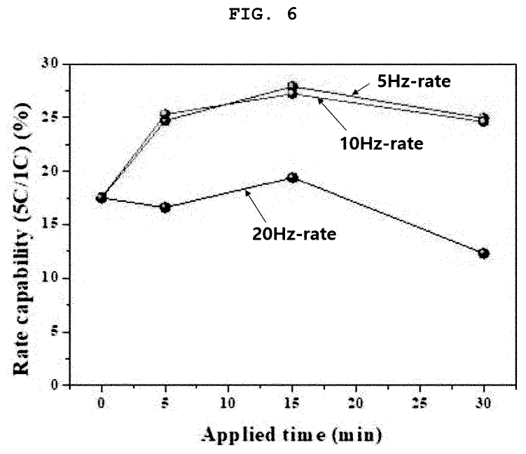

Referring to Table 3 and FIG. 6, when the magnetic field frequency was 5 Hz as in Examples 1 to 3 and when the magnetic field frequency was 10 Hz as in Examples 4 to 6, it was confirmed that the discharge capacity ratio was high in the case of applying the magnetic field for the same period of time as compared with not only the comparative example to which the magnetic field was not applied but also Examples 7 to 9 having the magnetic field frequency of 20 Hz. In addition, even in the case of applying the magnetic field having the frequency, when the magnetic field same application time was 15 minutes (Examples 2, 5, and 8), it was confirmed that the discharge capacity ratio was high. Therefore, when a magnetic field having a frequency of 5 Hz or 10 Hz was applied for 15 minutes as in Example 2 or 5, it was confirmed that the discharge capacity ratio was the highest at 27.9% or 27.2%.

TABLE 3

| | Discharge capacity |
|---|---|
| | ratio (1 C/5 C) (%) |
| Example 1 | 24.6 |
| Example 2 | 27.9 |
| Example 3 | 24.9 |
| Example 4 | 25.3 |
| Example 5 | 27.2 |
| Example 6 | 24.6 |
| Example 7 | 18.6 |
| Example 8 | 19.4 |
| Example 9 | 18.3 |
| Comparative Example | 17.5 |

### 4. Evaluation of Retention Rate by Cycle (Cycle Retention)

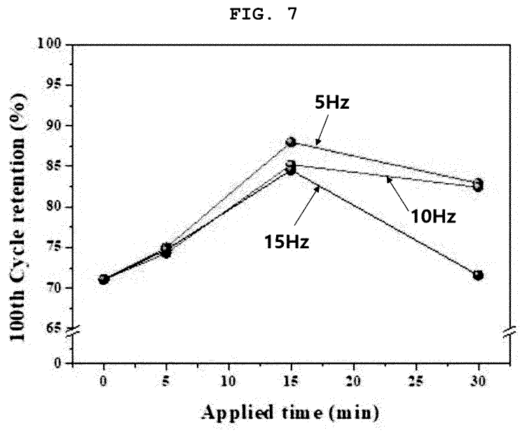

Referring to Table 4 and FIG. 7, when the magnetic field frequency was 5 Hz as in Examples 1 to 3 and when the magnetic field frequency was 10 Hz as in Examples 4 to 6, it was confirmed that the retention rate was high in the case of applying the magnetic field for the same period of time as compared with not only the comparative example to which the magnetic field was not applied but also Examples 7 to 9 having the magnetic field frequency of 20 Hz. In addition, even in the case of applying the magnetic field having the same frequency, when the magnetic field application time was 15 minutes (Examples 2, 5, and 8), it was confirmed that the retention rate was high. Therefore, when a magnetic field having a frequency of 5 Hz or 10 Hz was applied for 15 minutes as in Example 2 or 5, it was confirmed that the retention rate was the highest at 88% or 85.2%.

| | 100^{th} cycle |
|---|---|
| | retention |
| | rate (%) |
| Example 1 | 75 |
| Example 2 | 88 |
| Example 3 | 82.4 |
| Example 4 | 74.3 |
| Example 5 | 85.2 |
| Example 6 | 82.9 |
| Example 7 | 74.7 |
| Example 8 | 84.5 |
| Example 9 | 71.6 |
| Comparative Example | 71.1 |

1. A method for manufacturing a lithium secondary battery, the method comprising:
(a) an electrode plate process step of manufacturing a positive electrode plate and a negative electrode plate;
(b) an assembly process step of performing assembly by including a separator in the positive electrode plate and the negative electrode plate and injecting an electrolyte solution to manufacture a cell; and
(c) an activation process step of performing a formation process on the manufactured cell,
wherein a magnetic field is applied in the formation process of (c).

2. The method for manufacturing a lithium secondary battery of claim 1, wherein the applied magnetic field has an intensity of 0.1 to 2.0 T.

3. The method for manufacturing a lithium secondary battery of claim 1, wherein the applied magnetic field has a frequency of 1 to 30 Hz.

4. The method for manufacturing a lithium secondary battery of claim 1, wherein an application time of the applied magnetic field is 1 to 60 minutes.

5. The method for manufacturing a lithium secondary battery of claim 1, wherein a current applied in (c) is 0.01 to 1.0 C.

6. The method for manufacturing a lithium secondary battery of claim 1, wherein a time of the current applied in (c) is 1 to 10 hours.

7. A lithium secondary battery manufactured by the method of claim 1.

8. The lithium secondary battery of claim 7, wherein the lithium secondary battery has an initial discharge capacity of 20 mAh/g or more.

9. The lithium secondary battery of claim 7, wherein the lithium secondary battery has an initial coulombic efficiency of 858 or more.

10. The lithium secondary battery of claim 7, wherein the lithium secondary battery has a discharge capacity ratio of 18% or more.
